(19) United States
(12) Patent Application Publication
(10) Pub. No.: US 2026/0035030 A1
(43) Pub. Date: Feb. 5, 2026

(54) STEERING DEVICE

(71) Applicant: Hitachi Astemo, Ltd., Hitachinaka-shi, Ibaraki (JP)

(72) Inventor: Teruyuki OHNISHI, Ibaraki (JP)

(21) Appl. No.: 18/996,386

(22) PCT Filed: Sep. 4, 2023
(86) PCT No.: PCT/JP2023/032179

§ 371 Date: Jan. 17, 2025

(30) Foreign Application Priority Data
Sep. 15, 2022 (JP) 2022-146846

(51) Int. Cl. B62D 5/04

(52) U.S. Cl. CPC B62D 5/0421; B62D 5/0403

(57) ABSTRACT

Provided is a steering device that can be improved in assembly workability. A sensor-side connector is oriented at an angle to a pinion shaft. An EPP includes a first terminal to which a first harness is connected and a second terminal to which a second harness is connected. The first terminal is provided closer to the pinion shaft than the second terminal is. The first harness has length that is set shorter than the second harness.

### TECHNICAL FIELD

The invention relates to steering devices.

### BACKGROUND ART

Patent Literature 1 discloses a rack-and-pinion steering device comprising a power steering device, the steering device being improved in fault tolerance by making the wiring redundant.

### CITATION LIST

### Patent Literature

PTL 1: Japanese Patent Application Publication (Kokai) No. 2004-216928

### SUMMARY OF INVENTION

### Technical Problem

The steering device discussed in Patent Literature 1 cannot be improved in workability in connecting a torque sensor provided on a pinion shaft side and a controller of an electric motor which is provided on a rack shaft side with two-system wiring, and there has been a need for improvement in such connecting workability.

An object of the invention is to provide a steering device that can be improved in assembly workability.

### Solution to Problem

According to a steering device of one embodiment of the invention, a sensor-side connector is oriented at an angle to a pinion shaft, and a controller includes a first terminal to which a first harness is connected and a second terminal to which a second harness is connected. The first terminal is provided closer to the pinion shaft than the second terminal is. The first harness has length that is set shorter than the second harness.

The steering device of the one embodiment of the invention thus can be improved in assembly workability.

### BRIEF DESCRIPTION OF DRAWINGS

FIG. 1 is a schematic diagram showing a steering device 1 of Embodiment 1 as viewed from a front side of a vehicle.

FIG. 2 is a schematic diagram showing a main part of the steering device 1 of Embodiment 1 as viewed from a rear side of the vehicle.

FIG. 3 shows a preassembled state of a first harness 17 and a second harness 18 of Embodiment 1.

FIG. 4 is a longitudinal sectional view of a steering gear housing 9 which shows a state immediately before a sensor-side connector 16 is attached to the steering gear housing 9.

FIG. 5 is a longitudinal sectional view of the steering gear housing 9 which shows a state where the sensor-side connector 16 is attached to the steering gear housing 9.

FIG. 6 is a schematic diagram showing a main part of a steering device 1A of Embodiment 2 as viewed from a rear side of a vehicle.

FIG. 7 is an enlargement view of a main part of a steering gear housing 9 which shows a sensor-side connector 16 of Embodiment 2.

### DESCRIPTION OF EMBODIMENTS

### Embodiment 1

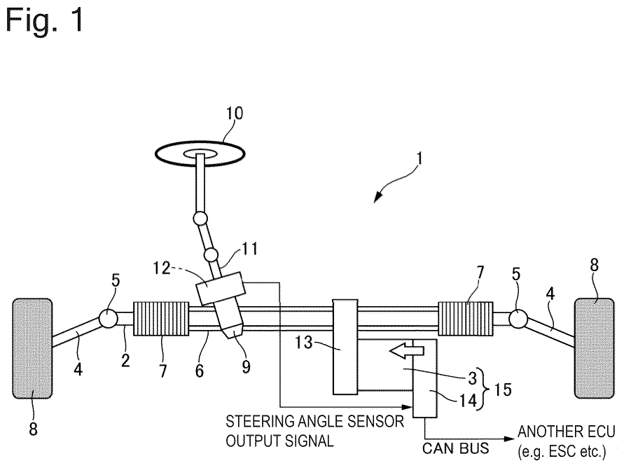

FIG. 1 is a schematic diagram showing a steering device 1 of Embodiment 1 as viewed from a front side of a vehicle.

The steering device 1 is a rack-and-pinion steering device comprising an electric motor 3 that imparts a turning force to a rack shaft 2. The rack shaft 2 extends in a lateral direction of the vehicle. A tie rod 4 is connected through a joint 5 to each end of the rack shaft 2. The rack shaft 2 is accommodated in a rack housing 6. The rack housing 6 includes end portions, each of which is covered with a boot 7. The rack shaft 2 includes end portions protruding from the boots 7. The tie rods 4 are moved by displacement of the rack shaft 2, and front wheels (turned wheels) 8 are turned through the tie rods 4.

A steering gear housing 9 is provided on one end side (left side in FIG. 1) of the rack housing 6. An input shaft 11 is rotatably and axially supported in the steering gear housing 9. The input shaft 11 is linked to a steering wheel 10. The input shaft 11 is connected to a pinion shaft, not shown, through a torsion bar, not shown, to be rotatable relative to the pinion shaft.

A torque steering angle sensor (sensor portion) 12 is provided in an upper portion of the steering gear housing 9. The torque steering angle sensor 12 outputs a steering angle sensor output signal according to a relative rotation amount of the input shaft 11 and the pinion shaft.

The pinion shaft is meshed with the rack shaft 2 and transmits a steering torque inputted to the steering wheel 10 to the rack shaft 2.

Provided on the other end side (right side in FIG. 1) of the rack housing 6 is an actuator housing 13. The actuator housing 13 accommodates an assist mechanism to which the electric motor 3 is fixed and which transmits the output of the electric motor 3 to the rack shaft 2. The assist mechanism transmits a driving force of the electric motor 3 through an input pulley, a belt, and an output pulley to a nut and converts the driving force into an axial thrust force of the rack shaft 2 using a ball screw mechanism. Instead of the belt, a chain may be utilized.

The electric motor 3 is a so-called EPS power pack in which a motor ECU (controller) 14 is integrally included. The motor ECU 14 receives not only the steering angle sensor output signal from the torque steering angle sensor 12, but also information from another ECU (engine ECU, for example) and another sensor (wheel speed sensor, for example) through CAN communication. The motor ECU 14 drives and controls the electric motor 3 in accordance with various pieces of information. In the following discussion, the electric motor 3 and the motor ECU 14 are collectively referred to as an EPP 15.

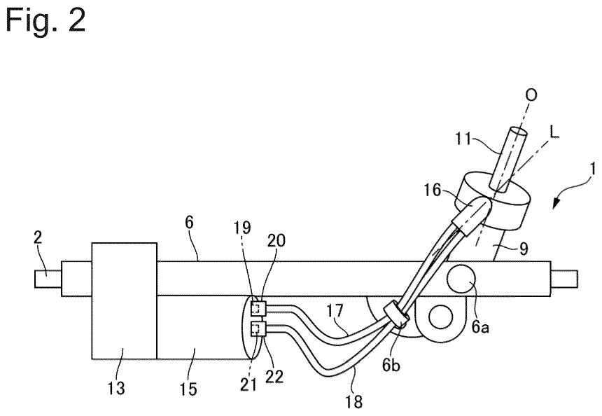

FIG. 2 is a schematic diagram showing a main part of the steering device 1 of Embodiment 1 as viewed from a rear side of the vehicle.

The torque steering angle sensor 12 is provided with a sensor-side connector 16. A first harness 17 and a second harness 18 are connected to the sensor-side connector 16. The first harness 17 has length that is set shorter than the second harness 18. The first harness 17 is provided with a motor-side first connector 20 in an end portion located on an opposite side from the sensor-side connector 16. The motor-side first connector 20 is connectable to a first terminal 19 of the EPP 15. The second harness 18 is provided with a motor-side second connector 22 in an end portion located on an opposite side from the sensor-side connector 16. The motor-side second connector 22 is connectable to a second terminal 21 of the EPP 15. The first terminal 19 is provided closer to the steering gear housing 9 (pinion shaft) than the second terminal 21 is.

An adjust screw 6a is attached to the rack housing 6. The adjust screw 6a is intended to adjust a set load of a coil spring that biases the rack shaft 2 toward the pinion shaft through a rack retainer, not shown.

A clip 6b is also attached to the rack housing 6. The clip 6b is for fixing the first harness 17 and the second harness 18 to the rack housing 6. The clip 6b holds the first harness 17 and the second harness 18 at a longitudinally and substantially central position of the first and second harnesses 17 and 18.

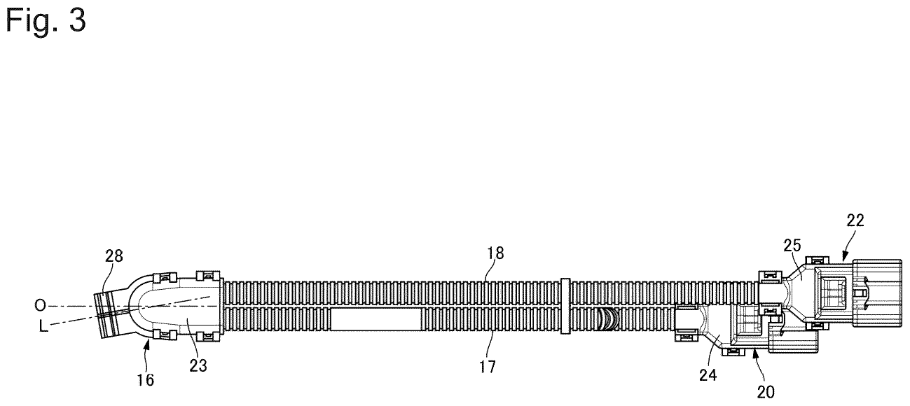

FIG. 3 is a view showing a preassembled state of the first harness 17 and the second harness 18 of Embodiment 1.

Each of the first harness 17 and the second harness 18 is a corrugated tube enclosing a plurality of electric wires. The sensor-side connector 16 includes a protecting portion 23 with which the first harness 17 and the second harness 18 are covered. Likewise, the motor-side first connector 20 and the motor-side second connector 22 also include a first protecting portion 24 and a second protecting portion 25 with which the first harness 17 and the second harness 18 are respectively covered. The first harness 17 and the second harness 18 each enclose a single-system wiring. In other words, the torque steering angle sensor 12 is designed to have two-system wiring. The single-system wiring comprises a signal wire and a power source wire of the torque steering angle sensor 12. For example, if the sensor is a three-wire sensor, the single-system wiring comprises a signal wire and two power source wires.

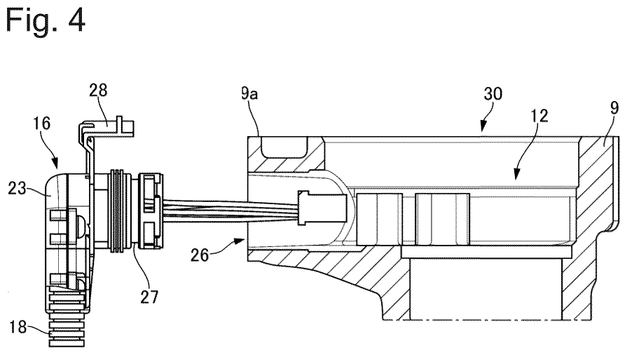

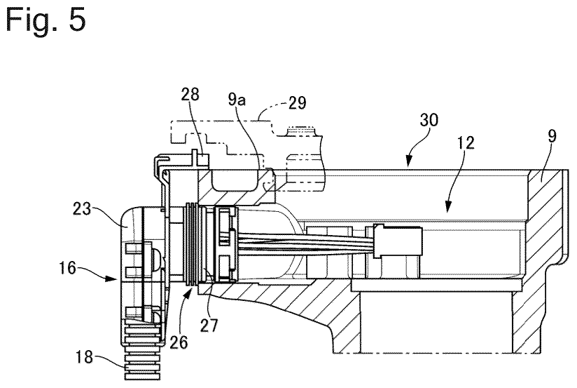

The sensor-side connector 16 includes a fixed portion 27 that is insertable into a connector insertion opening 26 that is provided in the steering gear housing 9. The connector insertion opening 26 is formed to have a substantially rectangular shape and opens radially with respect to a rotational axis direction of the pinion shaft as illustrated in FIG. 4. The fixed portion 27 is provided on a distal end side (opposite side from the first harness 17 and the second harness 18) of the protecting portion 23 and extends perpendicularly to the protecting portion 23. Assuming that a two-dimensional coordinate is set, which includes a plane parallel with the rotational axis direction of the pinion shaft, the fixed portion 27 has an angle to the protecting portion 23. When the sensor-side connector 16 is assembled to the steering gear housing 9 (see FIG. 5), therefore, a straight line L along an extending direction of (the protecting portion 23 of) the sensor-side connector 16 has an angle to a rotational axis O of the pinion shaft.

The protecting portion 23 in the sensor-side connector 16 includes a rotation stopper portion 28 for fixing the sensor-side connector 16 to the steering gear housing 9. The rotation stopper portion 28 protrudes from a distal end of the protecting portion 23 to be bent at an angle of 90 degrees. A distal end portion of the rotation stopper portion 28 is formed to have a substantially L-like shape which extends in a direction along the fixed portion 27. As illustrated in FIG. 5, when the sensor-side connector 16 is assembled to the steering gear housing 9, the distal end portion of the rotation stopper portion 28 is lodged between an upper face 9a of the steering gear housing 9 and a cover 29, to thereby regulate the rotation of the sensor-side connector 16. The cover 29 is intended to close an opening portion 30 of the steering gear housing 9. The opening portion 30 is formed for the torque steering angle sensor 12 to be inserted in the steering gear housing 9.

The following discussion will explain the operation and advantageous effects provided by Embodiment 1.

As concerns a rack-and-pinion steering device comprising a power steering device, if a harness connecting a torque sensor and a controller is made redundant (two-system), a power steering function can continue to be carried out when one of the harnesses is disconnected or failed due to external environment. In such a rack-and-pinion steering device, if the torque sensor and the controller are connected in the shortest distance, the harnesses overlap with a head portion of an adjust screw attached to a housing.

Accordingly, a tightening tool possibly interferes with the harnesses when being attached in an assembly process, which deteriorates workability.

By way of contrast, the steering device 1 of Embodiment 1 is so configured that the straight line L along the extending direction of (the protecting portion 23 of) the sensor-side connector 16 has an angle to the rotational axis O of the pinion shaft, and that the adjust screw 6a is disposed on the rotational axis O of the pinion shaft. Since the sensor-side connector 16 is oriented at an angle to the pinion shaft, starting points of the first and second harnesses 17 and 18 can be forcibly changed. This makes it possible to avoid the interference of the first and second harnesses 17 and 18 with the adjust screw 6a.

According to the steering device 1 of Embodiment 1, furthermore, the EPP 15 includes the first terminal 19 to which the first harness 17 is connected and the second terminal 21 to which the second harness 18 is connected. The first terminal 19 is provided closer to the pinion shaft than the second terminal 21 is. The first harness 17 has length that is set shorter than the second harness 18. The first harness 17 is thus restrained from being connected to the second terminal 21, which prevents incorrect assembly.

Consequently, the steering device 1 of Embodiment 1 can be improved in assembly workability.

The first harness 17 of Embodiment 1 includes the motor-side first connector 20 that is connectable to the first terminal 19, and the second harness 18 includes the motor-side second connector 22 that is connectable to the second terminal 21. That is, providing a connector on the EPP 15 side as well makes it possible to reduce the wiring length of the first and second harnesses 17 and 18.

The sensor-side connector 16 of Embodiment 1 includes the fixed portion 27 to be fixed to the steering gear housing 9 in which the pinion shaft is accommodated. Embodiment 1 thus provides an effect of preventing the sensor-side connector 16 from coming off after being assembled and an effect of preventing foreign materials or the like from entering into the steering gear housing 9.

The sensor-side connector 16 includes the rotation stopper portion 28 that regulates the rotation of the sensor-side connector 16 by being lodged between the cover 29 attached to the steering gear housing 9 and the steering gear housing 9. This prevents disconnection of the first harness 17 and the second harness 18 which is attributable to the rotation of the sensor-side connector 16.

The sensor-side connector 16 further includes the protecting portion 23 that covers the end portion of the first harness 17 and the end portion of the second harness 18, to thereby restrain foreign materials or the like from entering into the sensor-side connector 16.

The first and second harnesses 17 and 18 according to Embodiment 1 are corrugated tubes each enclosing a plurality of electric wires. Corrugated tubes have excellent flexibility and characteristics such as high compressive resistance and flame retardancy, and therefore make it possible to prevent disconnection and improve assemblability.

Since the first harness 17 and the second harness 18 each enclose the single-system wiring, even if the harness of either one of the systems is disconnected, the EPP 15 can receive a signal from the torque steering angle sensor 12 through the harness of the other system. The power steering function therefore can continue to be carried out.

### Embodiment 2

As Embodiment 2 is similar in basic configuration to Embodiment 1, the following discussion will only explain differences with Embodiment 1.

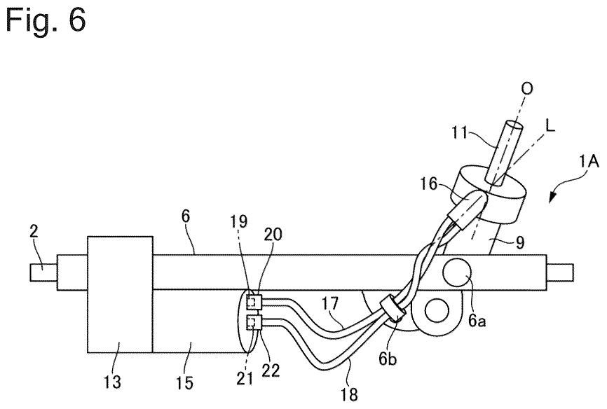

FIG. 6 is a schematic diagram showing a main part of a steering device 1A of Embodiment 2 as viewed from a rear side of a vehicle.

In the steering device 1A of Embodiment 2, a first harness 17 and a second harness 18 are assembled in a state twisted 360 degrees around each other.

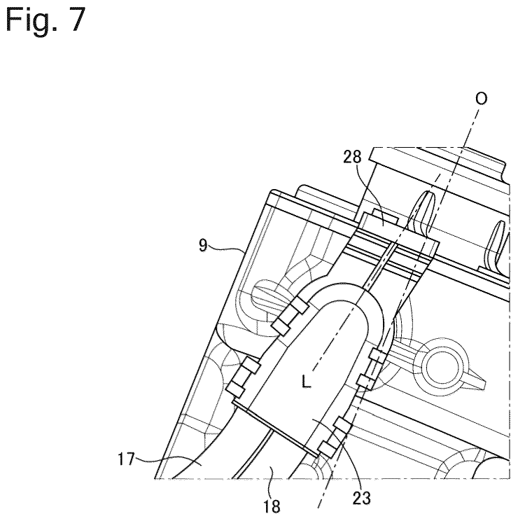

As illustrated in FIG. 7, according to Embodiment 2, a fixed portion 27 and a rotation stopper portion 28 are parallel with a straight line L along an extending direction of (a protecting portion 23 of) a sensor-side connector 16. In other words, the fixed portion 27 and the rotation stopper portion 28 have an angle to a rotational axis O of a pinion shaft.

Operation and advantageous effects of Embodiment 2 will be now discussed.

Since the first and second harnesses 17 and 18 in the steering device 1A of Embodiment 2 are assembled in the state twisted around each other, it is possible to sterically form the cable routing of the first and second harnesses 17 and 18. The cable routing of the first and second harnesses 17 and 18 can be placed further away from an adjust screw 6a, as compared to Embodiment 1. This makes it possible to avoid interference without difficulty and improve assembly workability.

### OTHER EMBODIMENTS

The embodiments for carrying out the invention have been explained. The specific configurations of the invention are not limited to those of the embodiments, and any configuration that is modified in design or the like without deviating from the gist of the invention may be included in the invention.

For example, the number of harnesses may be three or more.

The present application claims priority under Japanese Patent Application No. 2022-146846 filed on Sep. 15, 2022. The entire disclosure of Japanese Patent Application No. 2022-146846 filed on Sep. 15, 2022 including the description, claims, drawings and abstract is incorporated herein by reference in its entirety.

### REFERENCE SIGN LIST

1: Steering device, 1A: Steering device, 2: Rack shaft, 3: Electric motor, 12: Torque steering angle sensor (sensor portion), 14: Motor ECU (controller), 16: Sensor-side connector, 17: First harness, 18: Second harness, 19: First terminal, 21: Second terminal

1. A rack-and-pinion steering device, the rack-and-pinion steering device comprising:
an electric motor configured to impart a turning force to a rack shaft;
a controller provided integrally with the electric motor;
a sensor portion provided on a side of a pinion shaft and configured to detect a steering amount;
a sensor-side connector attached to the sensor portion; and
a first harness and a second harness which connect the sensor-side connector and the controller,
the sensor-side connector being so disposed that an extending direction of the first harness and an extending direction of the second harness have a radial angle to a direction along a rotational axis of the pinion shaft;
the controller including a first terminal to which the first harness is connected and a second terminal to which the second harness is connected;
the first terminal being provided closer to the pinion shaft than the second terminal is; and
the first harness having length that is set shorter than the second harness.

2. The steering device according to claim 1,
wherein the first harness includes a motor-side first connector that is connectable to the first terminal, and
wherein the second harness includes a motor-side second connector that is connectable to the second terminal.

3. The steering device according to claim 2,
wherein the sensor-side connector includes a fixed portion to be fixed to a housing in which the pinion shaft is accommodated.

4. The steering device according to claim 3,
wherein the sensor-side connector includes a rotation stopper portion configured to regulate rotation of the sensor-side connector by being lodged between a cover attached to the housing and the housing.

5. The steering device according to claim 4,
wherein the fixed portion and the rotation stopper portion are disposed in the housing so that the extending direction of the first harness and the extending direction of the second harness have an angle to the direction along the rotational axis of the pinion shaft.

6. The steering device according to claim 5,
wherein the sensor-side connector includes a protecting portion that covers an end portion of the first harness and an end portion of the second harness.

7. The steering device according to claim 1,
wherein the first harness and the second harness are corrugated tubes each enclosing a plurality of electric wires.

8. The steering device according to claim 7,
wherein the first harness and the second harness each enclose a single-system wiring.

9. The steering device according to claim 8,
wherein the first harness and the second harness are assembled in a twisted state.
